(19) United States
(12) Patent Application Publication
(10) Pub. No.: US 2023/0004986 A1
(43) Pub. Date: Jan. 5, 2023

(54) DETERMINING IDENTIFYING INFORMATION OF CUSTOMERS

(71) Applicant: OPTX Solutions, LLC, Las Vegas, NV (US)

(72) Inventors: Thomas Rafferty, Las Vegas, NV (US); Rukmangada Reddy Rupanagudi, Pleasanton, CA (US); Michael Roy Hartwig, Las Vegas, NV (US)

(21) Appl. No.: 17/364,282

(22) Filed: Jun. 30, 2021

(51) Int. Cl. G06Q 30/00; G06F 16/9035; G06F 16/9038

(52) U.S. Cl. CPC G06Q 30/016; G06F 16/9035; G06F 16/9038

(57) ABSTRACT

Systems and methods for determining identifying information associated with a customer of a service business are disclosed. Data indicative of assets associated with a service business may be received from at least one database. Data indicative of a plurality of interactions with at least one device of the service business may be determined based on the data indicative of assets associated with the service business. An identity associated with at least one customer of the service business may be determined based on the data indicative of the plurality of interactions with the at least one device of the service business. The identity may indicate, for example, a identify of an unknown customer of the service business. As another example, the identify may indicate a relationship between two known customers of the service business.

### BACKGROUND

A service business may need to have a comprehensive understanding of its customers and/or its operations in order to be successful. For example, a service business may have unhappy customers and/or lack profitability if it does not have a sufficient understanding of its customers and/or its operations. However, it may be difficult for a service business to gain a sufficient understanding of its customers and/or its operations. For example, it may be difficult for a service business to determine identifying information associated with all of its customers. This difficulty may be especially prevalent for those service businesses that have a large number of customers and/or one or more large properties to oversee. Therefore, improvements in service management techniques are needed.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for distributing content.

FIG. 2 shows an example system for integrating disparate data.

FIG. 3 shows an example method for determining identifying information associated with one or more customers of a service business.

FIG. 4 shows another example method for determining identifying information associated with one or more customers of a service business.

FIG. 5 shows another example method for determining identifying information associated with one or more customers of a service business.

FIG. 6 shows another example method for determining identifying information associated with one or more customers of a service business.

FIG. 7 shows another example method for determining identifying information associated with one or more customers of a service business.

FIG. 8 shows an example computing device which may be used to perform any of the techniques disclosed herein.

### DETAILED DESCRIPTION OF ILLUSTRATIVE EMBODIMENTS

The present systems and methods relate to systems and methods for determining identifying information associated with customers of a service business. Embodiments of the present disclosure comprise systems and methods for tracking customers that are unknown (e.g., unregistered) to the service business. Other embodiments of the present disclosure comprise systems and methods for determining existing relationship between known customers of the service business.

A service business may include any type of business, including but not limited to, casino properties, hotel properties, resort properties, time share properties, vacation properties, amusement parks, food and beverage businesses, vineyards, car dealerships, office buildings, universities, and/or any other business that manages assets associated with a business that includes multiple different operational aspects. A service business may be associated with a single property or multiple properties. If a service business is associated with multiple properties, each of these properties may be located in different locations and/or on-line.

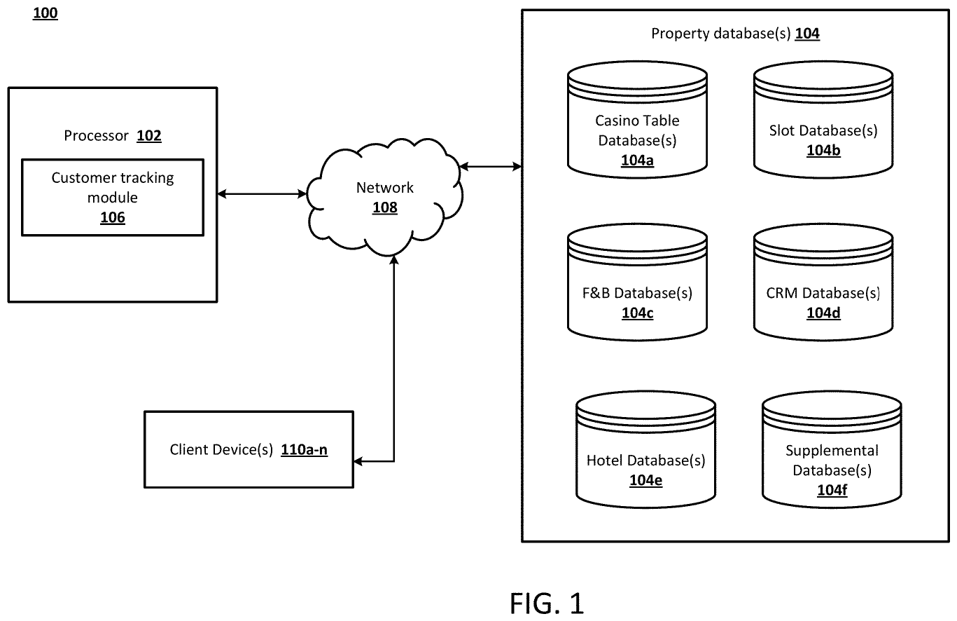

FIG. 1 illustrates an example platform 100 for determining identifying information associated with customers of a service business. The platform 100 may comprise a processor 102, one or more property databases 104, and one or more client devices 110a-n. The processor 102, one or more property databases 104, and one or more client devices 110a-n may communicate with each other via one or more networks 108. The network 108 may comprise a variety of network devices, such as routers, switches, multiplexers, hubs, modems, bridges, repeaters, firewalls, proxy devices, and/or the like. The network 108 may comprise physical links, such as coaxial cable links, twisted pair cable links, fiber optic links, a combination thereof, and/or the like. The network 108 may comprise wireless links, such as cellular links, satellite links, Wi-Fi links and/or the like.

The processor 102 may process tasks associated with the platform 100. For example, the processor 102 may comprise a customer tracking module 106. The customer tracking module 106 may be configured to determine identifying information associated with customers of a service business. The processor 102 and/or the customer tracking module 106 may be associated with an entity other than the service business itself. For example, an entity that is not the service business may utilize the customer tracking module 106 to determine identifying information associated with customers of a service business.

The customer tracking module 106 may determine identifying information associated with customers of a service business using data collected and/or maintained by one or more properties of the service business. The customer tracking module 106 may receive, from one or more property databases 104a-e, data indicative of assets associated with the service business. Assets associated with the service business include customers and/or devices (e.g. machines) associated with the service business. For example, if the service business is a casino, assets associated with the service business may include customers of the casino and/or devices (e.g. slot machines, casino tables, etc.) of the casino.

The customer tracking module 106 may utilize the received data to determine identifying information associated with customers of the service business. For example, the customer tracking module 106 may utilize the received data to tie disparate pieces of information to a single customer, that may or may not be known. In an embodiment, the customer tracking module 106 may utilize the received data to draw a relationship mapping between two different customers, each of which may or may not be known. In another embodiment, the customer tracking module 106 may utilize the received data to draw a relationship mapping between a set of data and an unknown customer.

If the customer tracking module 106 utilizes the received data to draw a relationship mapping between two different customers, the customer tracking module 106 may utilize the received data to determine if two different, known customers are related. Two different customers may be related if they are likely to visit a property of the service business at the same time as each other. For example, if the service business is a casino, two customers may be related if they tend to visit a property of the casino on the same days or times and/or if they tend to play in the same area, such as banks of machines or tables, at the same time.

If the customer tracking module 106 utilizes the received data to draw a relationship mapping between a set of data and an unknown customer, the customer tracking module 106 may utilize the received data to track an unknown customer. An unknown customer may be a customer that is not known to the service business. A customer may not be known to the service business, for example, if the customer has not visited a property of the service business before, if the customer has not registered as a known customer of the service business and/or the customer has not yet been identified.

For example, if the service business is a casino, a customer may be an unknown customer if the customer is an uncarded player. An uncarded player may be a player that has not registered to become a carded player with the casino. A carded player may be a player associated with a casino card. A casino card may allow the carded player to earn points when he or she plays (slot machines, table games, poker, etc.). The casino card may additionally offer various advantages depending on volume of the carded player's play (e.g., discounts on restaurants, bars rooms for your next stay, etc.). Points earned using the casino card may also be converted into casino credits.

In an embodiment, to draw a relationship mapping between a set of data and an unknown customer, the customer tracking module 106 may utilize the received data to determine whether a plurality of interactions with a single device (e.g., a machine) are each associated with a particular unknown customer. For example, the customer tracking module 106 may utilize the received data to determine whether the particular unknown customer interacted with the single device over an extended period of time.

To determine whether a plurality of interactions with a single device (e.g., a machine) are each associated with a particular unknown customer, the customer tracking module 106 may utilize the received data to determine a time associated with each interaction of the plurality of interactions. If the amount of time between each interaction of the plurality of interactions with the device satisfies a threshold, it may be determined that each of the plurality of interactions with the device is associated with the same unknown customer.

For example, if the service business is a casino, a first interaction with the device may be a ticket having credits associated with the ticket being entered into the device. A second, later interaction with the device may be a new bill being entered into the device (without a ticket being output from the device since the ticket was input). If there is only a short amount of time (e.g., around a few seconds to a minute) between the credit expiring and the insertion of a new bill, it may be determined that the same unknown customer is continually interacting with the device, i.e., after having used up the credit the unknown customer has not input new money into the machine. If the amount of time is longer before new money is input, that may indicate that the unknown customer has left the machine and someone else has started to play at the machine.

The threshold may be any predetermined amount of time (e.g., any number of seconds and/or minutes). The amount of time between each interaction of the plurality of interactions with the device may satisfy the threshold if the amount of time between each interaction of the plurality of interactions is less than or equal to the threshold. For example, if the threshold is one minute, and the amount of time between each interaction of the plurality of interactions is less than or equal to one minute, each of the plurality of interactions with the device may be associated with the same unknown customer.

Alternatively, the customer tracking module 106 may utilize the received data to determine that it was not a single unknown customer that interacted with the single device over the extended period of time. For example, if the amount of time between each interaction of the plurality of interactions with the device does not satisfy the threshold, each of the plurality of interactions with the device may not be associated with the same unknown customer. Rather, at least one of the plurality of interactions with the device may be associated with a different customer than the remainder of the plurality of interactions. As a result, it may be determined that the particular unknown customer was not the only customer that interacted with (e.g., played) that device over the period of time that includes the plurality of interactions.

As discussed above, the threshold may be any predetermined amount of time (e.g., any number of seconds and/or minutes). The amount of time between each interaction of the plurality of interactions with the device may fail to satisfy the threshold if the amount of time between each interaction of the plurality of interactions exceeds the threshold. For example, if the threshold is one minute, and the amount of time between each interaction of the plurality of interactions is greater than one minute, each of the plurality of interactions with the device may not be associated with the same unknown customer.

In another embodiment, to draw a relationship mapping between a set of data and an unknown customer, the customer tracking module 106 may utilize the received data to determine whether a plurality of interactions with a plurality of devices (e.g., machines) are each associated with a particular unknown customer. For example, the customer tracking module 106 may utilize the received data to determine whether the particular unknown customer interacted with the plurality of devices over an extended period of time.

To determine whether a plurality of interactions with a plurality of devices (e.g., machines) are each associated with a particular unknown customer, the customer tracking module 106 may utilize the received data to determine that a first device has output a ticket (e.g., an indicator) associated with a particular unknown customer. The customer tracking module 106 may also utilize the received data to determine that a second, different device (e.g., another machine, a cashier, etc.) has received, at a later time, the ticket that was output by the first device. If the customer tracking module 106 determines that the second, different device has received the ticket that was output by the first device, the customer tracking module may determine that the single, unknown customer interacted with the first device and then moved to interact with the second device.

In another embodiment, to draw a relationship mapping between a set of data and an unknown customer, the customer tracking module 106 may utilize the received data to determine whether a plurality of interactions share a common behavioral pattern. For example, if the service business is a casino, the customer tracking module 106 may utilize the received data to determine whether the plurality of interactions share a common pattern of play. There may only be a certain number of players on a casino floor at one time, and each may play in a slightly unique fashion (e.g., level of risk, numbers of credits played, patters of play, etc.). If the customer tracking module 106 determines that the plurality of interactions with one or more devices share a common behavioral pattern the customer tracking module may determine that a single, unknown customer is associated with each of the plurality of interactions.

As discussed above, the customer tracking module 106 may additionally or alternatively utilize the received data to draw a relationship mapping between two different known customers or unknown customers. To draw a relationship mapping between two different known or unknown customers, the customer tracking module 106 may utilize the received data to determine whether a plurality of interactions with one or more devices (e.g., machines) tie or link the two different customers together.

In an embodiment, to determine whether a plurality of interactions with one or more devices (e.g., machines) tie or link the two different known customers together, the customer tracking module 106 may utilize the received data to determine that a first device has received a ticket and an indication (e.g., player ID) associated with a first known customer. The customer tracking module 106 may additionally utilize the received data to determine that the first device has output the ticket. The customer tracking module 106 may additionally utilize the received data to determine that a second device has received, as input, the first ticket and an indication (e.g., player ID) associated with a second known customer. The second device may be the same as or different than the first device. If the customer tracking module 106 determines that a second device has received, as input, the first ticket and an indication (e.g., player ID) associated with the second known customer, the customer tracking module 106 may determine that the first and second known customers are related to one another. If the first and second known customers are related to one another, this may indicate that the first and second known customers are likely to visit a property of the service business at the same time and/or are likely to be friends, acquaintances, family members, associates, etc.

In another embodiment, to determine whether a plurality of interactions with one or more devices (e.g., machines) tie or link the two different known customers together, the customer tracking module 106 may utilize the received data to determine a quantity of times that a first known customer and a second known customer are simultaneously located proximate to at least one device. The received data may include, for example, geolocation data collected through a phone application.

If the quantity of times satisfies a threshold, this may indicate that the first known customer and the second known customer are likely to be located near each other when located on a property of the service business. If the first known customer and the second known customer are likely to be located near each other when located on a property of the service business, this may indicate that the first and second known customers are related to one another. As discussed above, if the first and second known customers are related to one another, this may indicate that the first and second known customers are likely to visit a property of the service business at the same time and/or are likely to be friends, acquaintances, family members, associates, etc.

In yet another embodiment, to determine whether a plurality of interactions with one or more devices (e.g., machines) tie or link the two different known customers together, the customer tracking module 106 may utilize the received data to determine a first plurality of time periods during which a first known customer interacted with at least one device of the service business. The customer tracking module 106 may additionally utilize the received data to determine a second plurality of time periods during which the second customer interacted with the at least one device of the service business.

If an overlap between the first plurality of time periods and the second plurality of time periods satisfies a threshold, this may indicate that the first known customer and the second known customer are likely to visit a property of the service business at the same time. If the first known customer and the second known customer are likely to visit a property of the service business at the same time, this may indicate that the first and second known customers are related to one another. As discussed above, if the first and second known customers are related to one another, this may indicate that the first and second known customers are likely to visit a property of the service business at the same time and/or are likely to be friends, acquaintances, family members, associates, etc.

In another embodiment, to determine whether a plurality of interactions with one or more devices (e.g., machines) tie or link the two different known customers together, the customer tracking module 106 may utilize the received data to determine one or more attributes associated with a first known customer and a second known customer of the service business. The attributes may include, by way of example and without limitation, address(es) and/or phone number(s). If a first known customer and a second known customer of the service business share a common address and/or phone number, this may indicate that the first and second known customers are related to one another.

In another embodiment, to determine whether a plurality of interactions with one or more devices (e.g., machines) tie or link the two different known customers together, the customer tracking module 106 may utilize the received data to determine one or more social media attributes associated with a first known customer and/or a second known customer of the service business. For example, the customer tracking module 106 may utilize the received data to determine that the first known customer and the second known customer are “friends” with one another on social media. If a first known customer and a second known customer of the service business interact with each other on social media (e.g., are “friends), this may indicate that the first and second known customers are related to one another, truly are friends, etc.

In another embodiment, to determine whether a plurality of interactions with one or more devices (e.g., machines) tie or link the two different known customers together, the customer tracking module 106 may utilize the received data to determine whether two different known customers are likely staying in the same hotel. For example, the customer tracking module 106 may utilize the received data to determine that a first known customer checks into a hotel using an indication (e.g., player ID) associated with the second known customer. If the first known customer checks into a hotel using the indication (e.g., player ID) associated with the second known customer, this may indicate that the first and second known customers are related to one another or otherwise connected. Additionally, or alternatively, the customer tracking module 106 may utilize the received data to determine how many key cards for a hotel are issued (e.g., two key cards may indicate that two people are staying in the room). If two customers are staying in the same hotel room, this may indicate that they are related to one another.

The customer tracking module 106 may utilize the received data in any other manner to tie or link the two different known customers together. For example, if the customer tracking module 106 receives data from a food and beverage database (e.g., F&B database 104c), the customer tracking module 106 may utilize the received data to determine that multiple player IDs are listed on a single food/beverage check and may show they are related. If the indications (e.g., player IDs) associated with the first and second known customers are both listed on a single food/beverage check, this may indicate that the first and second known customers are related to one another. Additionally, or alternatively, the customer tracking module 106 may utilize the received data to determine that, although food and/or a beverage was paid for by a first known customer, a player ID of a second known customer was used to facilitate the purchase. This may indicate that the first and second known customers are related to one another.

In the same manners that the customer tracking module 106 may tie or link two different known customers together, the customer tracking module 106 may also tie or link a known customer to an unknown customer or tie or link two unknown customers. For example, the spouse or friend of a known customer may not want to be known by the service business, but may accompany a known player on a frequent basis. The service business may be tempted to invite the known player to an event or to give the known player some type of perk or comp, but doing so without also inviting the unknown player may inhibit the known player in some manner, so the known player may be given two invitations or double perks or comps so the known player can possibly share with the unknown player and both will participate.

The customer tracking module 106 may use the determined identifying information to determine one or more tasks that need to be completed with respect to one or more customers of the service business. For example, if the customer tracking module 106 determines that a particular unknown customer interacted with one or more devices over an extended period of time, the customer tracking module 106 may determine that an employee of the service business needs to interact with that particular unknown customer. For example, the customer tracking module 106 may determine that an employee of the service business needs to greet the particular unknown customer and/or attempt to convert the unknown customer into a known (e.g., carded) customer. Alternatively, if the unknown customer indicates that he or she does not wish to be converted into a known (e.g., carded) customer, the employee may be able to ascertain why the customer does not want to be carded, which information may be entered in a database with information about the unknown customer so if identified in the future, the unknown customer is not approached again. Additionally, or alternatively, the customer tracking module 106 may determine that an employee of the service business needs to extend an offer or promotion to the unknown customer. For example, the employee may offer a three-night hotel night stay, buffet tickets, etc., to the unknown customer.

As another example, if the customer tracking module 106 determines that a relationship between a first customer of the service business and a second customer of the service business exists, the customer tracking module 106 may determine that an employee of the service business needs to invite the second customer to any event that the first customer is also invited to. If the first customer and second customer are related, this may indicate that the first customer may not want to attend an event without the second customer (and vice versa).

If the customer tracking module 106 determines one or more tasks that need to be completed with respect to one or more customers of the service business, the customer tracking module 106 may cause output of a message indicative of the at least one task that needs to be completed. For example, the customer tracking module 106 may cause output of a message indicative of the at least one task that needs to be completed via an interface of one or more client devices 110a-n. The one or more client devices 110a-n may be associated with (e.g., belong to) the service business and may be accessible by employees of the service business. One or more employees may utilize the one or more client devices 110a-n to view tasks that need to be completed, and to accept and/or deny one or more of these tasks.

The client devices 110a-n may comprise any type of computing device, such as a mobile device, a tablet device, laptop, a desktop computer, a smart television or other smart device (e.g., smart watch, smart speaker, smart glasses, smart helmet), a gaming device, a set top box, digital streaming device, robot, and/or the like. The client devices 110a-n may be associated with one or more users. A single user may use one or more of the client devices 110a-n to access the platform 100. The client devices 110a-n may travel to a variety of locations and use different networks to access the platform 100.

The processor 102 may be implemented as one or more computing devices, one or more processors, one or more virtual computing instances, a combination thereof, and/or the like. The processor 102 may be implemented by one or more computing devices. The one or more computing devices may comprise virtualized computing instances. The virtualized computing instances may comprise a virtual machine, such as an emulation of a computer system, operating system, server, and/or the like. A virtual machine may be loaded by a computing device based on a virtual image and/or other data defining specific software (e.g., operating systems, specialized applications, servers) for emulation. Different virtual machines may be loaded and/or terminated on the one or more computing devices as the demand for different types of processing services changes. A hypervisor may be implemented to manage the use of different virtual machines on the same computing device.

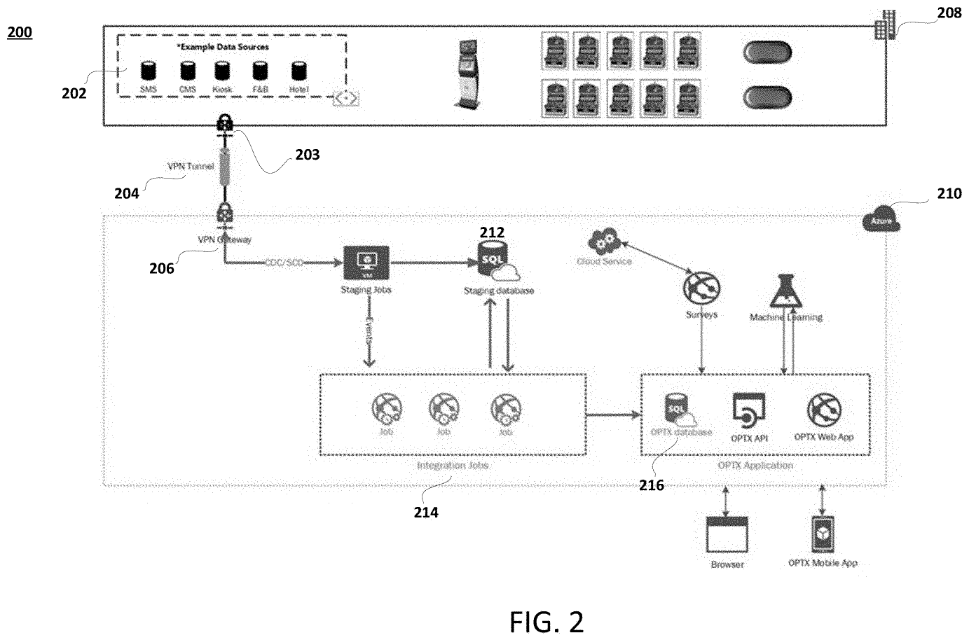

The data in the property databases 104 may be stored in disparate formats. For the customer tracking module 106 to be able to utilize the received data and analyze it, such as in the manner described above, the data from the property databases 104 may be integrated into a single format. FIG. 2 illustrates an example system 200 including a CMS for ingesting data in disparate formats from a service business. The data in disparate formats may come from a variety of different systems 202. For example, the systems 202 that generate data may include food & beverage systems, sportsbooks systems, slot systems, on-line gaming systems, hotel systems, casino systems, table systems, cashless systems, central credit systems, and/or any other system used to manage services at a property. The platform 100 may need to connect to all of these systems 202 and gather and store data from all of the systems 202 in a way that provides the platform 100 with the ability to leverage the data to provide insights and action to the user(s) of the platform 100.

However, connecting to all of these systems 202 and gathering data from the systems 202 may be challenging. Bringing all of the systems 202 together and connecting them back to an asset may be difficult at least in part because all of the data sources may be different in many ways. In an embodiment, the data may be extracted from each of the systems 202, transformed as necessary, and loaded into the platform 100 all in one step. For example, if the data associated with player wagers is desired, a query may be run to get that specific data from a source system 202, and a database associated with the platform 100 may be populated and presented to a user of the platform 100. However, this “one-step” treatment may prevent the platform 100 from being scalable and may lead to various data engineering issues. For example, any time any component or step in this one-step treatment needed to be modified, an entirely new version of the platform 100 may have to be reinstalled at each property that uses the platform 100. Accordingly, it may be desirable to connect disparate systems and gather data from them in different manner.

For example, it may be desirable to stage the disparate data in a staging database 212 separated from the systems 202 by a protective firewall 203. The staging database 212 may also be a replication database that replicates and stores any data received from the systems 202. A replication database may be necessary when the platform 100 is receiving data from a customer in a regulated industry, such as gaming, so that the data in the database may be made available to regulators without requiring it to be separated from other data and to insure all of the data is made available. The staging database 212 may also receive and store input data from the systems 202 so the data is separated from other portions of the platform 100 as well as from data input from other customers. There may also be a protective firewall (not shown, but the same as firewall 203) between the staging database 212 and other portions of platform 100. This separation of data from portions of the platform 100 facilitates the provisioning of custom input solutions to different customers, including outside of the gaming context. The separation and storage may be in physically different databases or in separated storage of a cloud-based service. Additionally, or alternatively, the staging database 212 may function as an enterprise data warehouse (EDW) for customers that desire this feature. The staging database 212 may also facilitate the return of customer data when a relationship with a customer terminates (e.g., the end of a contract), as the staging database 212, or at least its contents, may just be returned to the customer.

The data stored in the staging database 212 may be an exact replica of the source data. To get the data to stage in the staging database 212, various different techniques may be used. For example, a VPN tunnel 204 may be utilized to tunnel to each of the client systems 202. A VPN gateway 206 may be a connection point for the VPN tunnel 204. The VPN gateway 206 may contain the information that a device needs to establish the VPN tunnel 204 between a virtual network, such as Azure virtual network 210, and an on-premises location 208, such as a client property, over the public Internet.

To collect the data from the client systems 202 for storage in the staging database 212, change data capture (CDC) may be utilized. Alternatively, if the staging database 212 is a replication database, CDC may be utilized between the replication database and other portions of the platform 100. CDC is a set of software design patterns used to determine and track data that has changed so that actions can be taken using the changed data. CDC may be used to incrementally extract changed or new records from a client system 202 or replication database so that the whole database does not need to be downloaded for further processing each time. In an embodiment, CDC may read from logs in order to detect changes. While reading from logs may provide more details, it may impact performance as it puts more resource requirements on the client systems 202 and/or may result in the platform 100 receiving more data than the client wants the platform 100 to receive.

In another embodiment, CDC may read from tables in order to detect changes. Reading from tables may be similar to a database lookup and may require very little resources from the client systems 202. Reading from tables may also prevent the platform 100 from receiving more data than the client wants the platform 100 to receive. Each table may be timestamped so that CDC may look at each row in the table, compare it to the prior row in the table, and detect any change to the data. If a change to the data is detected, that change may be pulled into the staging database 212.

One or more databases from which the CDC reads tables may be relational databases that use “rowversion”. Rowversion is a data type that exposes automatically generated, unique binary numbers within a database. It may make it possible to version-stamp rows in a table with a unique sequential value that helps to maintain the integrity of the database when different users are updating rows at the same time. A relational database that uses rowversion may enable a different rowversion to be created each time there is a change to data. Accordingly, it may be easier to determine when changes have occurred to the data and what those changes are. If data has been changed multiple times, only the last (most recently created) rowversion may be sent for storage in the staging database 212. If a change to the data is detected, such as by detecting that a new sequence number has been created, that change may be pulled into the staging database 212. Alternatively, data may be pulled into the staging database 212 from intermediary rows if necessary or desired. For example, data may be pulled from intermediary rows into the staging database 212 if more details regarding the data change are desired. Additional details regarding the data change may be desired, for example, if there is a substantial amount of time in between the times when the CDC reads from the tables to detect changes.

Additionally, or alternatively, to collect the data from the client systems 202 for storage in the staging database 212, a slowly changing dimension (SCD) may be utilized. A SCD is a dimension that stores and manages both current and historical data over time in a data warehouse. A SCD allows for the maintenance of data changes in the data warehouse. These data changes may be related to dimensions that gradually change with time, rather than changing on a regular basis. Utilizing a SCD may be a way to apply updates to the staging database 212 so that the original source data is preserved. Some sources may maintain slot machine meters in one table. For example, when you insert a bill the meter gets updated from a previous value to a new value. Some source systems may only maintain the new value. A SCD may be utilized to both capture a previous value and a new value and have a trace of how the values are changing over time. For example, if a customer or player moves and gets a new address, some source systems may not track the previous addresses and when the address was changed. A SCD enables the new address and the previous address to be obtained and to make it clear that the customer as moved. As a result, more insight and useful information may be provided via the platform 100.

Additionally, or alternatively, data may need to be collected from the client systems 202 in real-time. Data may need to be collected from the client systems 202 in real-time if it is the type of data that changes frequently. For example, data associated with slot machine meters may change frequently and may need to be collected in real-time. The rows from real-time checks may go into ASAP tables in the platform 100. For example, if a property has software as a service (SaaS) data captured and stored in a server, this data may be taken directly from the feed of SaaS data and inserted into ASAP tables in the platform 100.

Once data is stored in the staging database 212, it may be integrated into a format that may be utilized by other portions of the platform 100. To integrate the data into this new format, different integration jobs 214 may be written. The integration jobs 214 may transfer data from the staging database 212, convert it into a different format for use within the platform 100, and populate a database associated with the platform 100, such as the database 216. A staging controller may manage jobs and keep metadata regarding which client source systems 202 are being tapped and which tables were checked. For example, the staging controller may indicate which job(s) are running, whether a job was successful or a failure, how long each job takes to run, etc.

The schema of the database associated with the platform 100, such as the database 216, may stay consistent irrespective of who the client is (e.g., which client is associated with the client source systems 202 and/or what the client source systems 202 are.) The schema may remain unchanged for different clients, but each instance of the platform 100's application may be different. One advantage of this design lays in the segregation between the staging database 212 and the integration schema. Each client of the platform 100 will each have its own staging schema, integration schema, and schema of the database associated with the platform 100. The data from various clients does not need to be commingled.

In an embodiment, at least some of the client data (e.g., the data from the client source systems 202) may be input into a data stream. The data stream may combine the client data with data from one or more other sources. The one or more other sources may provide data associated with various different topics, such as traffic, weather, or any other topic. The data stream combining the client data and the data from the one or more other sources may be used in an artificial-intelligence (AI) system to make predictions about why certain things occurred and/or to learn enough to plan for future events that might occur. For example, customer traffic during a certain period of time may be higher or lower than expected for reasons that are not clear based just on data provided from the systems 202, but could become clear when combined with data about the weather, traffic or other news sources. The client source data, such as the data from the client source systems 202, may need to be managed so that it is feed into the data stream in the correct order and can be time matched to the other source data.

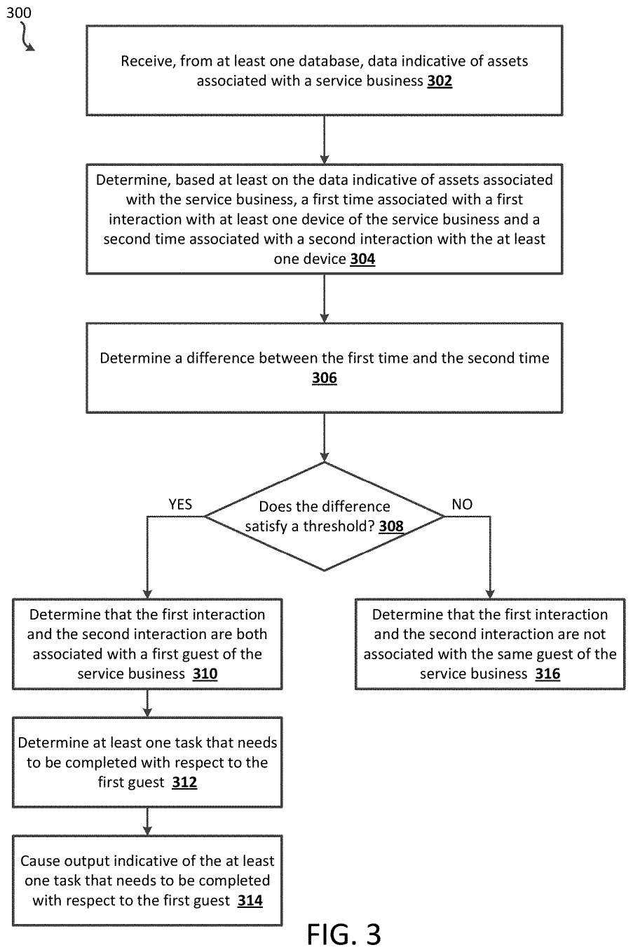

FIG. 3 illustrates an example process 300 performed by a customer tracking module (e.g., customer tracking module 106). The customer tracking module may perform the process 300 to determine identifying information associated with one or more customers of a service business. For example, the process 300 may be performed to determine whether a plurality of interactions with one or more devices (e.g., machines) of the service business over a period of time are each associated with a single unknown customer. Although depicted as a sequence of operations in FIG. 3, those of ordinary skill in the art will appreciate that various embodiments may add, remove, reorder, or modify the depicted operations.

At 302, data indicative of assets associated with a service business may be received. For example, the data indicative of assets associated with a service business may be received from one or more property databases 104. The received data may be utilized to determine whether a plurality of interactions with a single device (e.g., machine) or a plurality of different devices are each associated with a single, unknown customer. For example, the received data may be utilized to determine whether the single unknown customer interacted with the device(s) over an extended period of time, or whether several different customers interacted with the device(s) over the extended period of time.

To determine whether the plurality of interactions with the device(s) are each associated with a single unknown customer, the received data may be utilized to determine a time associated with each interaction of the plurality of interactions. At 304, a first time associated with a first interaction with a first device of the service business may be determined. The first time may be determined based at least on the data indicative of assets associated with the service business. A second time associated with a second interaction with a second device of the service business may additionally be determined. The second time may be determined based at least on the data indicative of assets associated with the service business. The first and second devices may be the same device or may be different devices associated with the service business.

If the amount of time between each interaction of the plurality of interactions with the device satisfies a threshold, it may be determined that each of the plurality of interactions with the device is associated with the same unknown customer. At 306, a difference between the first time and the second time may be determined. For example, if the first time occurred at noon on Jan. 1, 2021 and the second time occurred at 12:01 on Jan. 1, 2021, the difference between the first time and the second time may be one minute.

At 308, the difference may be compared to a threshold. The threshold may be any predetermined amount of time (e.g., any number of seconds and/or minutes). The amount of time between the first and second times may satisfy the threshold if the amount of time between the first and second times is less than or equal to the threshold. If the difference satisfies the threshold, the method 300 may proceed to 310. At 310, it may be determined that the first and second interactions are both associated with the same unknown customer of the service business. For example, if the threshold is one minute, and the amount of time between the first and second times is less than or equal to one minute, both of the first and second interactions with the device may be associated with the same unknown customer.

Conversely, if the difference fails to satisfy the threshold, the method 300 may proceed to 316. At 316, it may be determined that the first and second interactions are not both associated with the same unknown customer of the service business. For example, if the threshold is one minute, and the amount of time between the first and second times exceeds one minute, both of the first and second interactions with the device may not be associated with the same unknown customer. Rather the first and second interactions with the device may be associated with different unknown customers. As a result, it may be determined that the single unknown customer was not the only customer that interacted with (e.g., played) that device over the period of time that includes the first and second interactions. Nevertheless, data associated with the first and second interactions might be maintained in case either or both of those interactions can be associated with another interaction at a later point in time.

The determined identifying information may be used to determine one or more tasks that need to be completed with respect to the single unknown customer of the service business. At 312, at least one task that needs to be completed with respect to the single unknown customer of the service business may be determined. For example, it may be determined that an employee of the service business needs to interact with that single unknown customer. The task may indicate that the employee needs to greet the particular unknown customer and/or attempt to convert the unknown customer into a known (e.g., carded) customer. If the unknown customer indicates that he or she does not wish to be converted into a known (e.g., carded) customer, the employee may be able to understand why. Additionally, or alternatively, the task may indicate that an employee of the service business needs to extend an offer or promotion to the single unknown customer. For example, the employee may offer a three-night hotel night stay, buffet tickets, etc. to the single unknown customer.

If one or more tasks that need to be completed with respect to one or more customers of the service business are determined, output of a message indicative of the at least one task that needs to be completed may be caused. At 314, output indicative of the at least one task may be caused. For example, output of a message indicative of the at least one task that needs to be completed may be caused via an interface of one or more client devices (e.g., client devices 110a-n). The one or more client devices may be associated with (e.g., belong to) the service business and may be accessible by employees of the service business. One or more employees may utilize the one or more client devices to view tasks that need to be completed, and to accept and/or deny one or more of these tasks.

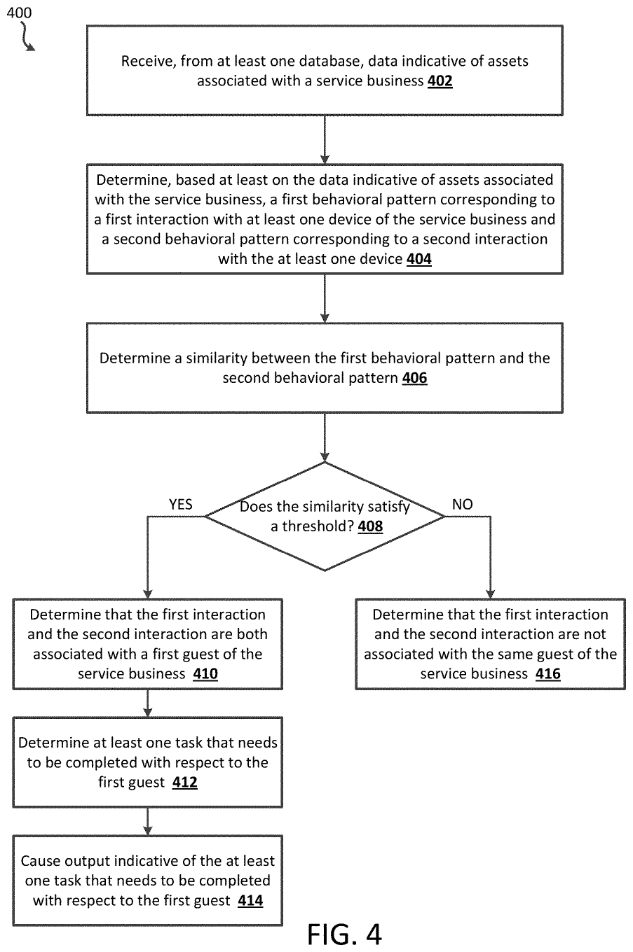

FIG. 4 illustrates another example process 400 performed by a customer tracking module (e.g., customer tracking module 106). The customer tracking module may perform the process 400 to determine identifying information associated with one or more customers of a service business. For example, the process 400 may be performed to determine whether a plurality of interactions with one or more devices (e.g., machines) of the service business over a period of time are each associated with a single unknown customer. Although depicted as a sequence of operations in FIG. 4, those of ordinary skill in the art will appreciate that various embodiments may add, remove, reorder, or modify the depicted operations.

At 402, data indicative of assets associated with a service business may be received. For example, the data indicative of assets associated with a service business may be received from one or more property databases 104. The received data may be utilized to determine whether a plurality of interactions with a single device (e.g., machine) or a plurality of different devices are each associated with a single, unknown customer. For example, the received data may be utilized to determine whether the single unknown customer interacted with the device(s) over an extended period of time, or whether several different customers interacted with the device(s) over the extended period of time.

At 404, a first behavioral pattern corresponding to a first interaction with at least one device of the service business may be determined. The first behavioral pattern may be determined based at least on the data indicative of assets associated with the service business. A second behavioral pattern corresponding to a second interaction with the at least one device may also be determined. The first interaction and the second interaction may be with the same device(s) or with different device(s). If the service business is a casino, the first behavioral pattern may include, for example, a first level of risk associated with the first interaction and the second behavioral pattern may include a second level of risk associated with the second interaction. While the first and second behavioral patterns may each indicate a level of risk, any other pattern of play may additionally or alternatively be indicated by the first and second behavioral patterns.

The first and second behavioral patterns may be utilized to determine whether the first and second interactions share a common behavioral pattern. For example, if the service business is a casino, the first and second behavioral patterns may be utilized to determine if the first and second interactions share a common pattern of play, such as a common level of risk. There may only be a certain number of players on a casino floor at one time, and each may play in a slightly unique fashion (e.g., level of risk, etc.). At 406, a similarity between the first and second behavioral patterns may be determined. The similarity may be determined using any known tool, technique, or method.

At 408, the similarity may be compared to a threshold. The threshold may be a predetermined threshold. The threshold may be indicative of a similarity level that, if satisfied, indicates that the first and second interactions are associated with the same customer. If the similarity satisfies the threshold, the method 400 may proceed to 410. The similarity may satisfy the threshold if the similarity meets or exceeds the threshold. At 410, it may be determined that the first and second interactions are both associated with the same unknown customer of the service business. For example, it may be determined that the first and second interactions with one or more devices share a common behavioral pattern, such as a common level of risk (e.g., high level of risk, medium level of risk, or low level of risk), common betting practices, etc.

Conversely, if the similarity fails to satisfy the threshold, the method 400 may proceed to 416. At 416, it may be determined that the first and second interactions are not both associated with the same unknown customer of the service business. For example, it may be determined that the first and second interactions with one or more devices do not share a common behavioral pattern, such as a common level of risk (e.g., high level of risk, medium level of risk, or low level of risk). Rather the first and second interactions with the device may be associated with different behavioral patterns, such as different levels of risk. As a result, it may be determined that the single unknown customer was not the only customer that interacted with (e.g., played) the device(s) over the period of time that includes the first and second interactions.

The determined identifying information may be used to determine one or more tasks that need to be completed with respect to the single unknown customer of the service business. At 412, at least one task that needs to be completed with respect to the single unknown customer of the service business may be determined. For example, it may be determined that an employee of the service business needs to interact with that single unknown customer. The task may indicate that the employee needs to greet the particular unknown customer and/or attempt to convert the unknown customer into a known (e.g., carded) customer. If the unknown customer indicates that he or she does not wish to be converted into a known (e.g., carded) customer, the employee may be able to understand why. Additionally, or alternatively, the task may indicate that an employee of the service business needs to extend an offer or promotion to the single unknown customer. For example, the employee may offer a three-night hotel night stay, buffet tickets, etc., to the single unknown customer.

If one or more tasks that need to be completed with respect to one or more customers of the service business are determined, output of a message indicative of the at least one task that needs to be completed may be caused. At 414, output indicative of the at least one task may be caused. For example, output of a message indicative of the at least one task that needs to be completed may be caused via an interface of one or more client devices (e.g., client devices 110a-n). The one or more client devices may be associated with (e.g., belong to) the service business and may be accessible by employees of the service business. One or more employees may utilize the one or more client devices to view tasks that need to be completed, and to accept and/or deny one or more of these tasks.

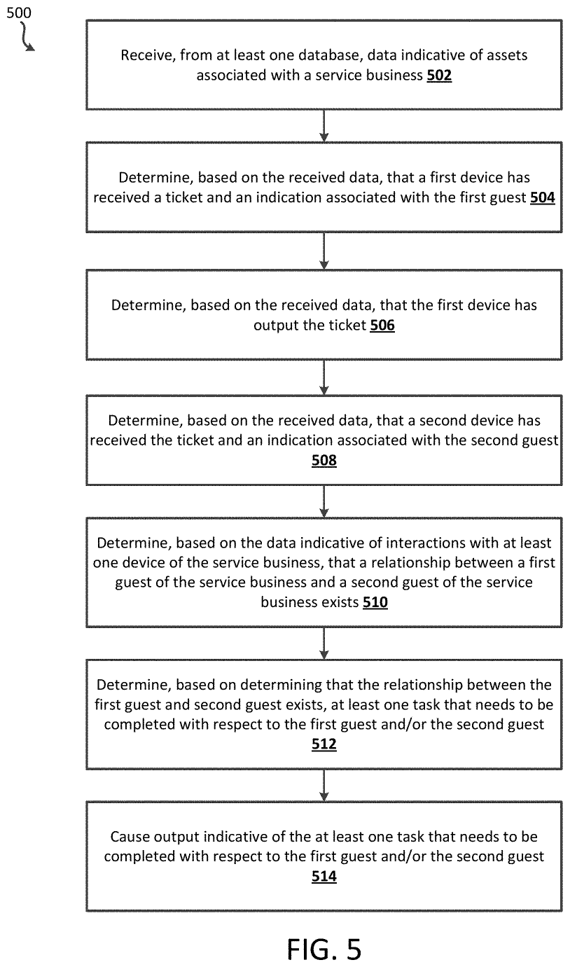

FIG. 5 illustrates another example process 500 performed by a customer tracking module (e.g., customer tracking module 106). The customer tracking module may perform the process 500 to determine identifying information associated with one or more customers of a service business. For example, the process 500 may be performed to determine whether a relationship exists between two known customers of a service business. Although depicted as a sequence of operations in FIG. 5, those of ordinary skill in the art will appreciate that various embodiments may add, remove, reorder, or modify the depicted operations.

At 502, data indicative of assets associated with a service business may be received. For example, the data indicative of assets associated with a service business may be received from one or more property databases 104. The received data may be utilized to determine whether a relationship exists between two known customers of the service business.

At 504, the received data may be utilized to determine that a first device has received, as input, a ticket and an indication (e.g., player ID) associated with a first known customer of the service business. The received data may additionally be utilized to determine that, at a later time, the first device output the ticket. At 506, it may be determined that the first device output the ticket that was input into the first device with the indication (e.g., player ID) associated with a first known customer of the service business. The received data may also indicate that the ticket was later inserted into a second device, but with a different player ID. At 508, it may be determined that a second device has received the ticket as input. It may also be determined that the second device has received, along with the ticket, an indication (e.g., player ID) associated with a second known customer of the service business. The second device may be the same as, or different from, the first device.

If it is determined that the second device has received, as input, the first ticket and an indication (e.g., player ID) associated with the second known customer, it may be determined that the first and second known customers are related to one another. At 510, it may be determined that a relationship exists between the first known customer and the second known customer. If a relationship exists between the first and second known customers, this may indicate that the first and second known customers are likely to visit a property of the service business at the same time and/or are likely to be friends, acquaintances, family members, associates, etc.

The determined relationship may be used to determine one or more tasks that need to be completed with respect to the first and/or second known customers of the service business. At 512, at least one task that needs to be completed with respect to the first and/or second known customer may be determined. For example, if a relationship between a first customer of the service business and a second customer of the service business exists, the task may indicate that an employee of the service business needs to invite the second customer to any event that the first customer is also invited to. If the first customer and second customer have a relationship, this may indicate that the first customer may not want to attend an event without the second customer (and vice versa).

If one or more tasks that need to be completed with respect to the first or second known customer are determined, output of a message indicative of the at least one task that needs to be completed may be caused. At 514, output indicative of the at least one task may be caused. For example, output of a message indicative of the at least one task that needs to be completed may be caused via an interface of one or more client devices (e.g., client devices 110a-n). The one or more client devices may be associated with (e.g., belong to) the service business and may be accessible by employees of the service business. One or more employees may utilize the one or more client devices to view tasks that need to be completed, and to accept and/or deny one or more of these tasks.

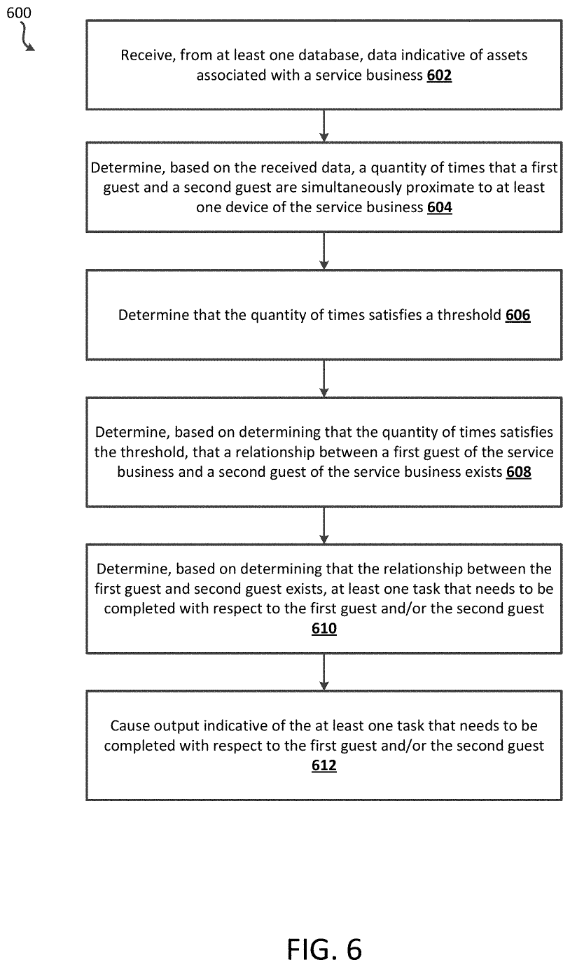

FIG. 6 illustrates another example process 600 performed by a customer tracking module (e.g., customer tracking module 106). The customer tracking module may perform the process 600 to determine identifying information associated with one or more customers of a service business. For example, the process 600 may be performed to determine whether a relationship exists between two known customers of a service business. Although depicted as a sequence of operations in FIG. 6, those of ordinary skill in the art will appreciate that various embodiments may add, remove, reorder, or modify the depicted operations.

At 602, data indicative of assets associated with a service business may be received. For example, the data indicative of assets associated with a service business may be received from one or more property databases 104. The received data may be utilized to determine whether a relationship exists between two known customers of the service business. The received data may include, for example, geolocation data collected through a phone application.

At 604, the received data may be utilized to determine a quantity of times that a first known customer of the service business and a second known customer of the service business are simultaneously proximate to at least one device or area associated with the service business. For example, the first and second known customers may be simultaneously proximate to at least one device associated with the service business if the first and second known customers are both sitting or standing near the same device(s) (e.g., within a predetermined distance, such as a certain number of inches, feet, or meters) at the same time.

If the quantity of times satisfies a threshold, this may indicate that the first known customer and the second known customer are likely to be located near each other when located on a property of the service business. At 606, it may be determined that the quantity of times satisfies a threshold. The threshold may be equal to any number of times within a certain time period. The quantity of times may satisfy the threshold if the quantity of times meets or exceeds the threshold. For example, if the threshold is five times within a time period (e.g., week, month, year, etc.), and the quantity of times that the first known and second known customers of the service business are simultaneously proximate to at least one device within that time period is six, then the quantity satisfies the threshold.

If the quantity of times the first and second known customers of the service business are simultaneously proximate to at least one device satisfies the threshold, this may indicate that a relationship exists between the first and second known customers. At 608, it may be determined that a relationship exists between the first and second known customers. As discussed above, if a relationship exists between the first and second known customers, this may indicate that the first and second known customers are likely to visit a property of the service business at the same time and/or are likely to be friends, acquaintances, family members, associates, etc.

The determined relationship may be used to determine one or more tasks that need to be completed with respect to the first and/or second known customers of the service business. At 612, at least one task that needs to be completed with respect to the first and/or second known customer may be determined. For example, if a relationship between a first customer of the service business and a second customer of the service business exists, the task may indicate that an employee of the service business needs to invite the second customer to any event that the first customer is also invited to. If the first customer and second customer have a relationship, this may indicate that the first customer may not want to attend an event without the second customer (and vice versa).

If one or more tasks that need to be completed with respect to the first or second known customer are determined, output of a message indicative of the at least one task that needs to be completed may be caused. At 614, output indicative of the at least one task may be caused. For example, output of a message indicative of the at least one task that needs to be completed may be caused via an interface of one or more client devices (e.g., client devices 110a-n). The one or more client devices may be associated with (e.g., belong to) the service business and may be accessible by employees of the service business. One or more employees may utilize the one or more client devices to view tasks that need to be completed, and to accept and/or deny one or more of these tasks.

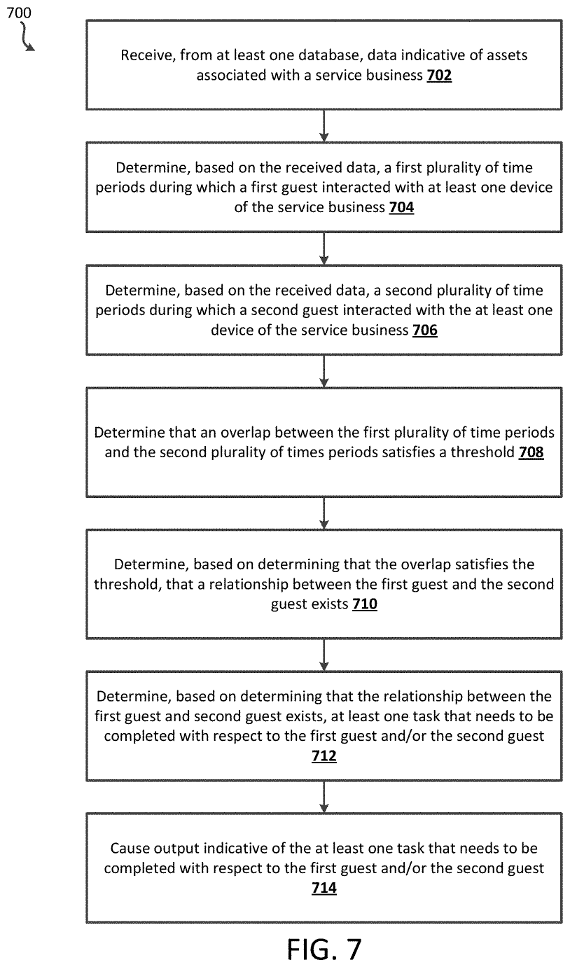

FIG. 7 illustrates another example process 700 performed by a customer tracking module (e.g., customer tracking module 106). The customer tracking module may perform the process 700 to determine identifying information associated with one or more customers of a service business. For example, the process 700 may be performed to determine whether a relationship exists between two known customers of a service business. Although depicted as a sequence of operations in FIG. 7, those of ordinary skill in the art will appreciate that various embodiments may add, remove, reorder, or modify the depicted operations.

At 702, data indicative of assets associated with a service business may be received. For example, the data indicative of assets associated with a service business may be received from one or more property databases 104. The received data may be utilized to determine whether a relationship exists between two known customers of the service business.

At 704, a first plurality of time periods during which a first customer interacted with at least one device of the service business may be determined. The first plurality of time periods during which the first customer interacted with the at least one device may be determined based on the received data. At 706, a second plurality of time periods during which a second customer interacted with the at least one device of the service business may be determined. The second plurality of time periods during which the second customer interacted with the at least one device may be determined based on the received data.

If an overlap between the first plurality of time periods and the second plurality of time periods overlaps frequently enough, this may indicate that the first known customer and the second known customer are likely to visit a property of the service business at the same time. At 708, it may be determined that an overlap between the first plurality of time periods and the second plurality of times periods satisfies a threshold. The threshold may be predetermined. The threshold may be any number or range of numbers. The overlap may satisfy the threshold, for example, if the first plurality of time periods and the second plurality of time periods overlap a quantity of times that meets or exceeds the threshold.

If the first known customer and the second known customer are likely to visit a property of the service business at the same time, this may indicate that the first and second known customers are related to one another. At 710, it may be determined that a relationship between the first known customer and the second known customer exists based on the overlap satisfying the threshold. As discussed above, if the first and second known customers are related to one another, this may indicate that the first and second known customers are likely to visit a property of the service business at the same time and/or are likely to be friends, acquaintances, family members, associates, etc.

The determined relationship may be used to determine one or more tasks that need to be completed with respect to the first and/or second known customers of the service business. At 712, at least one task that needs to be completed with respect to the first and/or second known customer may be determined. For example, if a relationship between a first customer of the service business and a second customer of the service business exists, the task may indicate that an employee of the service business needs to invite the second customer to any event that the first customer is also invited to. If the first customer and second customer have a relationship, this may indicate that the first customer may not want to attend an event without the second customer (and vice versa).

If one or more tasks that need to be completed with respect to the first or second known customer are determined, output of a message indicative of the at least one task that needs to be completed may be caused. At 714, output indicative of the at least one task may be caused. For example, output of a message indicative of the at least one task that needs to be completed may be caused via an interface of one or more client devices (e.g., client devices 110a-n). The one or more client devices may be associated with (e.g., belong to) the service business and may be accessible by employees of the service business. One or more employees may utilize the one or more client devices to view tasks that need to be completed, and to accept and/or deny one or more of these tasks.

Each of the methods illustrated in FIGS. 3-7 and as described herein may be combined with any of a number of other techniques for identifying individuals. For example, facial recognition may be used based on video and still images captured throughout a property to associate a particular face with a known or unknown customer. Captured images may also be submitted to databases to identify a name of the customer. Voice recognition may be utilized in a similar manner. Identification information captured when a customer checks into a hotel can be associated with other information captured elsewhere at the property, or other properties associated with the property. Identification information may also be captured when a customer is awarded a large jackpot for which the service business is required to report the winnings to tax authorities. License plate information collected from a parking lot may be used to identify a registered owner and then used to help identify a particular customer. Each of these customer identification techniques, and others not specifically mentioned herein, may be combined with determined identifying information as disclosed herein.

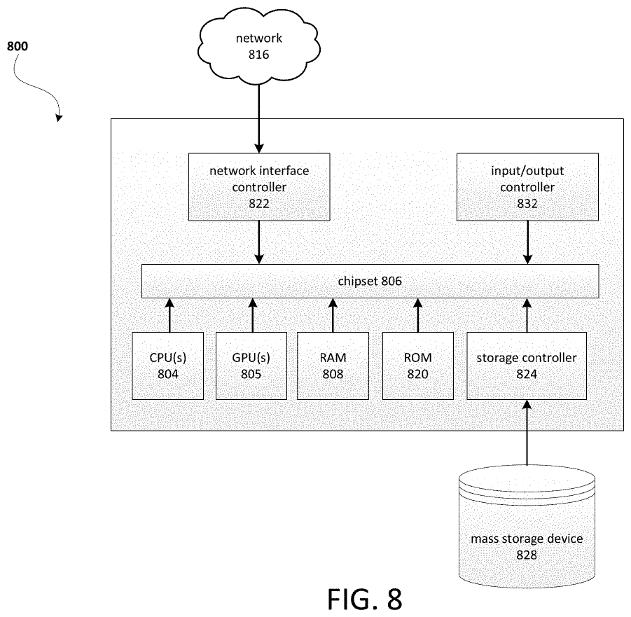

FIG. 8 illustrates a computing device that may be used in various aspects, such as the services, networks, modules, and/or devices depicted in FIG. 1. With regard to the example architecture of FIG. 1, the processor 102, customer tracking module 106, client devices 110a-n, network 108, and/or property databases 104a-f may each be implemented by one or more instance of a computing device 800 of FIG. 8. The computer architecture shown in FIG. 8 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 800 may include a baseboard, or “motherboard,” which is a printed circuit board to which a multitude of components or devices may be connected by way of a system bus or other electrical communication paths. One or more central processing units (CPUs) 804 may operate in conjunction with a chipset 806. The CPU(s) 804 may be standard programmable processors that perform arithmetic and logical operations necessary for the operation of the computing device 800.

The CPU(s) 804 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 804 may be augmented with or replaced by other processing units, such as GPU(s). The GPU(s) may comprise processing units specialized for but not necessarily limited to highly parallel computations, such as graphics and other visualization-related processing.

A chipset 806 may provide an interface between the CPU(s) 804 and the remainder of the components and devices on the baseboard. The chipset 806 may provide an interface to a random-access memory (RAM) 808 used as the main memory in the computing device 800. The chipset 806 may further provide an interface to a computer-readable storage medium, such as a read-only memory (ROM) 820 or non-volatile RAM (NVRAM) (not shown), for storing basic routines that may help to start up the computing device 800 and to transfer information between the various components and devices. ROM 820 or NVRAM may also store other software components necessary for the operation of the computing device 800 in accordance with the aspects described herein.

The computing device 800 may operate in a networked environment using logical connections to remote computing nodes and computer systems through local area network (LAN). The chipset 806 may include functionality for providing network connectivity through a network interface controller (NIC) 822, such as a gigabit Ethernet adapter. A NIC 822 may be capable of connecting the computing device 800 to other computing nodes over a network 816. It should be appreciated that multiple NICs 822 may be present in the computing device 800, connecting the computing device to other types of networks and remote computer systems.

The computing device 800 may be connected to a mass storage device 828 that provides non-volatile storage for the computer. The mass storage device 828 may store system programs, application programs, other program modules, and data, which have been described in greater detail herein. The mass storage device 828 may be connected to the computing device 800 through a storage controller 824 connected to the chipset 806. The mass storage device 828 may consist of one or more physical storage units. The mass storage device 828 may comprise a management component 810. A storage controller 824 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 800 may store data on the mass storage device 828 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 828 is characterized as primary or secondary storage and the like.

For example, the computing device 800 may store information to the mass storage device 828 by issuing instructions through a storage controller 824 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 800 may further read information from the mass storage device 828 by detecting the physical states or characteristics of one or more particular locations within the physical storage units.

In addition to the mass storage device 828 described above, the computing device 800 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 800.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 828 depicted in FIG. 8, may store an operating system utilized to control the operation of the computing device 800. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 828 may store other system or application programs and data utilized by the computing device 800.

The mass storage device 828 or other computer-readable storage media may also be encoded with computer-executable instructions, which, when loaded into the computing device 800, transforms the computing device from a general-purpose computing system into a special-purpose computer capable of implementing the aspects described herein. These computer-executable instructions transform the computing device 800 by specifying how the CPU(s) 804 transition between states, as described above. The computing device 800 may have access to computer-readable storage media storing computer-executable instructions, which, when executed by the computing device 800, may perform the methods described herein.

A computing device, such as the computing device 800 depicted in FIG. 8, may also include an input/output controller 832 for receiving and processing input from a number of input devices, such as a keyboard, a mouse, a touchpad, a touch screen, an electronic stylus, or other type of input device. Similarly, an input/output controller 832 may provide output to a display, such as a computer monitor, a flat-panel display, a digital projector, a printer, a plotter, or other type of output device. It will be appreciated that the computing device 800 may not include all of the components shown in FIG. 8, may include other components that are not explicitly shown in FIG. 8, or may utilize an architecture completely different than that shown in FIG. 8.

As described herein, a computing device may be a physical computing device, such as the computing device 800 of FIG. 8. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present disclosure may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving, from at least one database, data indicative of assets associated with a service business;
determining, based on the data indicative of assets associated with the service business, data indicative of a plurality of interactions with at least one device of the service business; and
determining, based on the data indicative of the plurality of interactions with the at least one device of the service business, an identity associated with at least one customer of the service business.

2. The method of claim 1, wherein determining, based on the data indicative of assets associated with the service business, the data indicative of the plurality of interactions with the at least one device of the service business comprises:
determining a time associated with each interaction of the plurality of interactions with a first device of the service business.

3. The method of claim 2, wherein a first time corresponds to a first interaction with the at least one device and a second time corresponds to a second interaction with the at least one device, and wherein determining, based on the data indicative of the plurality of interactions with the at least one device of the service business, the identity associated with the at least one customer of the service business comprises:
determining a difference between a first time and the second time; and
determining, based at least on the difference between the first time and the second time satisfying a threshold, that the first interaction and the second interaction are both associated with a first customer of the service business.

4. The method of claim 3, wherein the first time corresponds to the first interaction with a first device and wherein the second time corresponds to the second interaction with a second, different device.

5. The method of claim 1, wherein determining, based on the data indicative of assets associated with the service business, the data indicative of the plurality of interactions with the at least one device of the service business comprises:
determining a behavioral pattern associated with each interaction of the plurality of interactions with the at least one device.

6. The method of claim 5, wherein the behavioral pattern associated with each interaction of the plurality of interactions with the at least one device is indicative of a risk level associated with each interaction of the plurality of interactions with the at least one device.

7. The method of claim 5, wherein a first behavioral pattern corresponds to a first interaction with the at least one device and a second behavioral pattern corresponds to a second interaction with the at least one device, and wherein determining, based on the data indicative of the plurality of interactions with the at least one device of the service business, the identity associated with the at least one customer of the service business comprises:
determining a similarity between the first behavioral pattern and the second behavioral pattern; and
determining, based at least on the similarity between the first behavioral pattern and the second behavioral pattern satisfying a threshold, that the first interaction and the second interaction are both associated with a first customer of the service business.

8. The method of claim 7, wherein the first behavioral pattern corresponds to the first interaction with a first device and the second behavioral pattern corresponds to the second interaction with a second, different device.

9. The method of claim 7, wherein the first behavioral pattern is indicative of a first risk level associated with the first interaction and the second behavioral pattern is indicative of a second risk level associated with the second interaction.

10. The method of claim 1, wherein determining, based on the data indicative of the plurality of interactions with the at least one device of the service business, the identity associated with the at least one customer of the service business comprises:
determining that a relationship between a first customer of the service business and a second customer of the service business exists.

11. The method of claim 10, wherein determining, based on the data indicative of assets associated with the service business, the data indicative of the plurality of interactions with the at least one device of the service business comprises:
determining that a first device has received a ticket and an indication associated with the first customer;
determining that the first device has output the ticket; and
determining that a second device has received the ticket and an indication associated with the second customer.

12. The method of claim 10, wherein determining, based on the data indicative of assets associated with the service business, the data indicative of the plurality of interactions with the at least one device of the service business comprises:
determining a quantity of times that the first customer and the second customer are simultaneously located proximate to the at least one device, and wherein determining that the relationship between the first customer of the service business and the second customer of the service business exists comprises:
determining that the quantity of times satisfies a threshold.

13. The method of claim 10, wherein determining, based on the data indicative of assets associated with the service business, the data indicative of the plurality of interactions with the at least one device of the service business comprises:
determining a first plurality of time periods during which the first customer interacted with the at least one device of the service business; and
determining a second plurality of time periods during which the second customer interacted with the at least one device of the service business, and wherein determining that the relationship between the first customer of the service business and the second customer of the service business exists comprises:
determining that an overlap between the first plurality of time periods and the second plurality of time periods satisfies a threshold.

14. The method of claim 10, further comprising:
determining, based on the data indicative of assets associated with the service business, data indicative of attributes associated with the at least one customer of the service business, and wherein determining that the relationship between the first customer of the service business and the second customer of the service business exists is further based on at least a portion of the data indicative of attributes associated with the at least one customer of the service business.

15. The method of claim 14, wherein data indicative of attributes associated with the at least one customer of the service business comprises at least one of: one or more addresses associated with the at least one customer of the service business, one or more telephone numbers associated with at least one customer of the service business, and one or more social networks associated with at least one customer of the service business.

16. The method of claim 1, further comprising:
determining, based at least on the identity associated with the at least one customer of the service business, at least one task that needs to be completed with respect to the at least one customer.

17. The method of claim 14, further comprising:
causing output of a message indicative of the at least one task that needs to be completed with respect to the at least one customer.

18. The method of claim 1, wherein receiving, from at least one database, the data indicative of assets associated with the service business comprises:
receiving, in disparate formats, the data indicative of assets associated with the service business, the method further comprising, before determining the data indicative of the plurality of interactions with the at least one device of the service business:
integrating, into a single format, the data indicative of assets associated with the service business.

19. A computer-readable medium storing instructions that, when executed, cause:
receiving, from at least one database, data indicative of assets associated with a service business;
determining, based on the data indicative of assets associated with the service business, data indicative of a plurality of interactions with at least one device of the service business; and
determining, based on the data indicative of the plurality of interactions with the at least one device of the service business, an identity associated with at least one customer of the service business.

20. A system comprising:
at least one database associated with a service business;
at least one computing device in communication with the at least one database, the at least one computing device configured to:
receive, from the at least one database, data indicative of assets associated with the service business;
determine, based on the data indicative of assets associated with the service business, data indicative of a plurality of interactions with at least one device of the service business; and
determine, based on the data indicative of the plurality of interactions with the at least one device of the service business, an identity associated with at least one customer of the service business.
